(19) United States
(12) Patent Application Publication
(10) Pub. No.: US 2004/0153370 A1
(43) Pub. Date: Aug. 5, 2004

(54) Method and apparatus for facilitating a search for a pick up location

(76) Inventor: Ping Yang, Chino Hills, CA (US)

Correspondence Address: DONALD M CISLO ESQ, CISLO & THOMAS LLP, 233 WILSHIRE BOULEVARD SUITE 900, SANTA MONICA, CA, 90401-1211, US

(21) Appl. No.: 10/348,853

(22) Filed: Jan. 22, 2003

(51) Int. Cl. G06F 17/60

(52) U.S. Cl. 705/26; 705/7

(57) ABSTRACT

A method and apparatus for facilitating selection of a pick up location by a user. A user accesses a shipper's web site from a seller's web site in order to select a pick up location for an item purchased from the seller by the user when the user is uncertain of the address of a suitable pick up location. The user selects a pick up location using the shipper's web site and the pick up location is transmitted to the seller's web site for use in shipping the item to the user. The shipper's web site facilitates selection of a pick up location by the user by generating a set of possible pick up locations from which the user selects a pick up location. The set of possible pick up locations may be generated using a geographic location such as an address, landmark, zipcode, or other locality indicator. In addition, the set of possible pick up locations may be generated from a route entered by the user or a route generated by a shipper's server using route end points supplied by the user.

### BACKGROUND OF THE INVENTION

This invention relates generally to a methods for searching for pick up locations and more specifically to searching when a user conducts purchases over the Internet, through telephone calls, or purchases from a remote seller via other kinds of telecommunication techniques.

In a traditional order/deliver model, a shipper (such as UPS, FEDEX or US Postal Service) delivers a user's order to a user designated address. Problems occur when there is no one at the delivery address to receive the shipment as the shipper has to drop ship at the user's door even without someone in attendance. This practice increases the chance of loss of merchandise and disputes between the user, the seller, and the shipper. As an alternative, the shipper leaves a notice of re-delivery to the recipient with re-delivery schedule. However, for a typical recipient who is at work and not available during daytime, to wait at the delivering address for delivery is not feasible let alone re-delivery. As a result, the recipient has to travel to the shipper's office to pick up the goods to be delivered. The whole experience is inconvenient and frustrating.

Furthermore, under the traditional delivery model, the shipper ships all packages piece by piece, door to door to each recipient's address. The delivery route is long and so is the delivery cycle (a delivery cycle is the time occurred between the first delivery to the last). A long delivery route means delivery costs, such as fuel, depreciation on delivery equipment, personnel expenses . . . etc, will be high. A long delivery cycle means the tie-up time of delivery equipment and delivery personnel is long. A shorter delivery time may free up delivery equipment and delivery personnel for other assignments and thus saves operating costs.

Thus, there is a need to improve the current delivery model so that the problem of absence of recipient can be resolved and at the same time delivery routes and delivery cycles may be shortened.

The traditional delivery model also creates difficulties for the user. When the user goes on line to the seller's web site to shop, at the stage of checking out, the user is prompted to enter a delivery address and other delivery information. The delivery address is the address to where the user wants the user's goods to be shipped. The delivery address may be the user's home address, office address, or a friend's home address, etc. The delivery address is the information the user has to know beforehand and must provide to the seller to complete the shipping process. However, if the user wants the goods to be shipped to some other location where the user only knows the locations approximate geographical locality, and not the locations exact address and/or location, the current shipping model cannot provide a convenient solution for him.

A user may want to ship to another as yet unknown location for a variety of reasons. Consider the following scenario, user A orders goods on line and is at work during daytime and not available to be home to receive the user's goods nor does the user want the user's order to be shipped to the user's office. To receive the order, user A may want the goods the user ordered to be shipped to some other place where the user can pick it up. The place may be an office or an outlay of the shipper and it must be a place where is convenient for the user to travel to. It may be a shipper's office that is near the user's home, or near the user's office. It may also be a place that is along and near the route the user travels daily, e.g. the route the user travels to and from work every day, so that the user can pass by the location and pick the user's order up conveniently.

Under the traditional delivery model, instituted by shippers, a user, instead of requesting a package to be shipped to the user's home or office, may request the package to be delivered to a shipper's office the user selected. The user then arranges for a recipient (if not the user himself) to go to the carrier's office to pick the packup up.

Referring to FIG. 1-4, for example, this service is named “HOLD AT SHIPPER LOCATION SERVICE” 140 by a shipper 140. To use this delivery method, the user has to know the address of the shipper's office the user intends to ship the user's goods to. Shippers do provide a search module that allows the user to search, according to telephone number, address or zip code, or a shipper's office the user wants the user's order to be shipped to as illustrated in FIG. 1-1. In this search module, the shipper lists out the addresses of the shippers offices using a user input address, zip code, or telephone number as illustrated in FIG. 1-2. The shipper may also display a map with all offices covered by the user input address, zip code, or telephone number as illustrated in FIG. 1-3. Once the shipper obtains the address the user wants the user's order to be shipped to, the user then fills out a shipping label and designates the office as a shipping destination. The shipper may ask the user to provide telephone number. When the designated shipper's office receives the package, the shipper's office calls the recipient by telephone to notify the recipient to pick up the package is indicated at 142 of FIG. 1-4.

Because such a shipper's office is not the user's home, user's office, or other place familiar to the user, a user may have little or no knowledge about the availability, address and other information about such a location. That is, the user may not have enough knowledge about whether such an office (which is near the user's home or office) even exists. If it does exist, the user nay not know how far it is from the user's home, the location's address or operating hours, etc. To find such a location to use the user has to conduct some research. To perform the research, the Internet purchasing user has to leave the seller's web site and enter the the shipper's URL address to log on to the shipper's web site. Or as an alternative, the user may stay at the seller's web site and call the carrier's office for an answer. After conduction the user's research, the user obtains the address of the location the user wants the goods to be shipped to. The user then goes back to the seller's web site and inputs this information to the seller. The total search process is inconvenient to a user when the user's is shopping at a seller's web site.

### SUMMARY OF THE INVENTION

A method and apparatus for facilitating selection of a pick up location by a user is provided. A user accesses a shipper's web site from a seller's web site in order to select a pick up location for an item purchased from the seller by the user when the user is uncertain of the address of a suitable pick up location. The user selects a pick up location using the shipper's web site and the pick up location is transmitted to the seller's web site for use in shipping the item to the user. The shipper's web site facilitates selection of a pick up location by the user by generating a set of possible pick up locations from which the user selects a pick up location. The set of possible pick up locations may be generated using a geographic location such as an address, landmark, zipcode, or other locality indicator. In addition, the set of possible pick up locations may be generated from a route entered by the user or a route generated by a shipper's server using route end points supplied by the user.

In one aspect of the invention, a unique delivery scheduling system is presented which makes it easy for the user to search for a pick up location when the availability, address and locality of such delivery location is unknown to the user.

In another aspect of the invention, the delivery scheduling system generates shorter delivery routes and delivery cycles to improve delivery efficiency.

In another aspect of the invention, a first server transmits a pick up location request to a second server through a communications network. In response, the second server requests and receives a locality indicator from the user through the communications network. The second server generates a set of pick up locations using the locality indicator and a pick up location selection display using the set of pick up locations. The second server receives a pick up location-selection by the from the user using the pick up location selection display and generates a pick up location using the pick up location selection. The pick up location is then transmitted to the first server through the communications network.

In another aspect of the invention, the pick up location selection display includes a map indicating the location of each pick location in the set of pick up locations.

In another aspect of the invention, the pick up location selection display includes a list indicating the location of each pick up location in the set of pick up locations.

In another aspect of the invention, the locality indicator is a route traveled by the user. In this case, receiving a locality indicator from the user further includes receiving a first and second route end by the second server from the user and generating the route traveled by the user by the second server using the first route end and the second route end.

In another aspect of the invention, generating a set of pick up locations further includes selecting pick up locations within a specified distance from the route traveled by the user for inclusion in the set of pick up locations.

In another aspect of the invention, the route traveled by the user is a least travel time route. To generate the least travel time route, a set of sections with corresponding travel times are used in conjunction with the first and second route ends to generate the least travel time route.

In another aspect of the invention, generating a set of pick up locations further includes selecting pick up locations within a specified distance from the locality indicator for inclusion in the set of pick up locations.

In another aspect of the invention, a pick up location selection includes a set of preferred pick up locations and generating a pick up location further includes receiving a second pick up location selection from a second user and generating a pickup location from the intersection of a set of preferred pick up locations included in the pick up location selection and a second set of preferred pick up locations included in the second pick up location selection.

### BRIEF DESCRIPTION OF THE DRAWINGS

These and additional features, aspects, and advantages of the present invention will become better understood with regard to the following detailed description, appended claims, and accompanying drawings where:

FIG. 1 is a presentation of a traditional delivery address entering system;

FIG. 1-1 is a presentation of a shipper web page where the user may use an address or telephone number to search for shipper offices as a shipping destination;

FIG. 1-2 is a presentation of a shipper web page where a list is presented to the user with all shipper offices meeting the user's search criteria;

FIG. 1-3 is a presentation of a shipper web page where a map is presented to the user with all shipper offices under the user's search criteria;

FIG. 1-4 is a presentation of a shipper web page showing the use of “HOLD AT SHIPPER LOCATION SERVICE”;

FIG. 1-5 is a presentation of a second page of a shipper's web page shown in FIG. 1-4;

FIG. 2 is a flow chart of a pick up location selection process in accordance with an exemplary embodiment of the present invention;

FIG. 3 is a flow chart of obtaining pick up location codes in accordance with an exemplary embodiment of the present invention;

FIG. 4 is a diagram showing how a user selects more then one preferred pick up location in accordance with an exemplary embodiment of the present invention;

FIG. 5 is a diagram showing the shipper's delivery route for delivery shipments to all recipients in accordance with an exemplary embodiment of the present invention;

FIG. 6 is a diagram showing another aspect of shipper's delivery route to all recipients in accordance with an exemplary embodiment of the present invention;

FIG. 7 is a diagram presentation of two user selecting a common pick up location in accordance with an exemplary embodiment of the present invention;

FIG. 8 is a diagram showing the shipper's delivery options to complete delivery assignments;

FIG. 9 is a flow chart presentation of the procedure the user follows to select commuting routes and preferred pick up locations in accordance with an exemplary embodiment of the present invention;

FIG. 10 is a map presentation of user commuting route with route channels in accordance with an exemplary embodiment of the present invention; and

FIG. 11 is a block diagram of an architecture of a data processing system suitable for use as a shipper's server host in accordance with an exemplary embodiment of the present invention.

### DETAILED DESCRIPTION

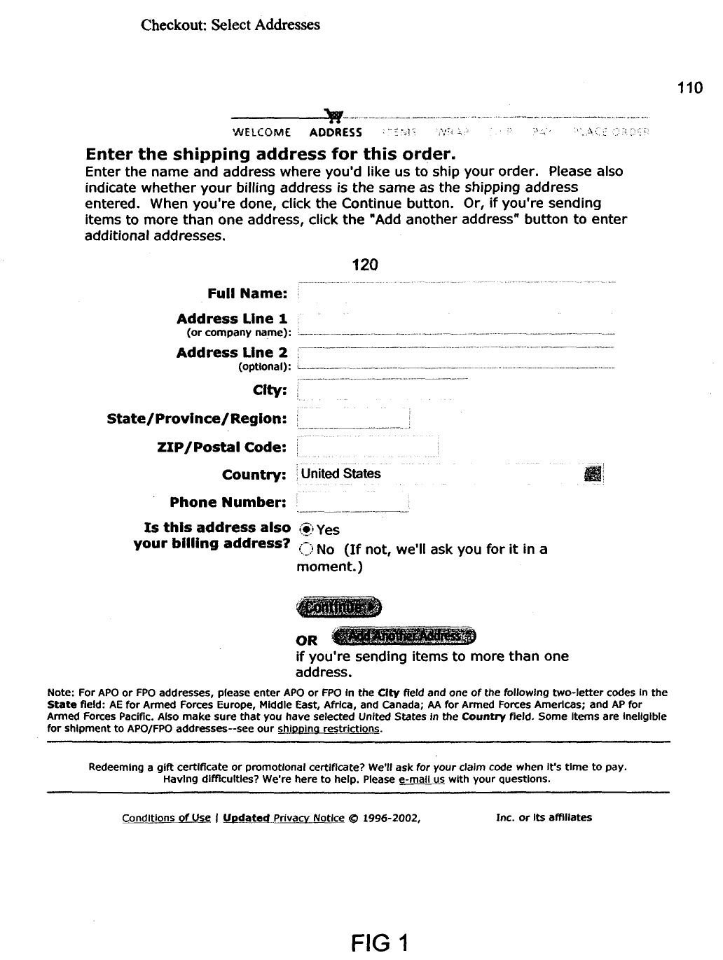

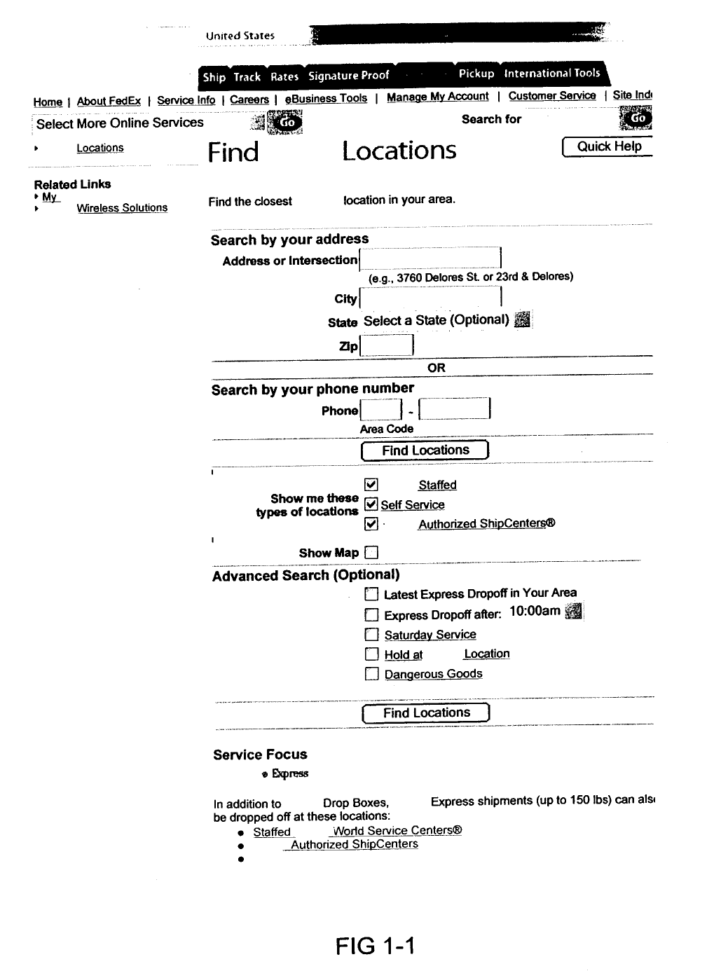

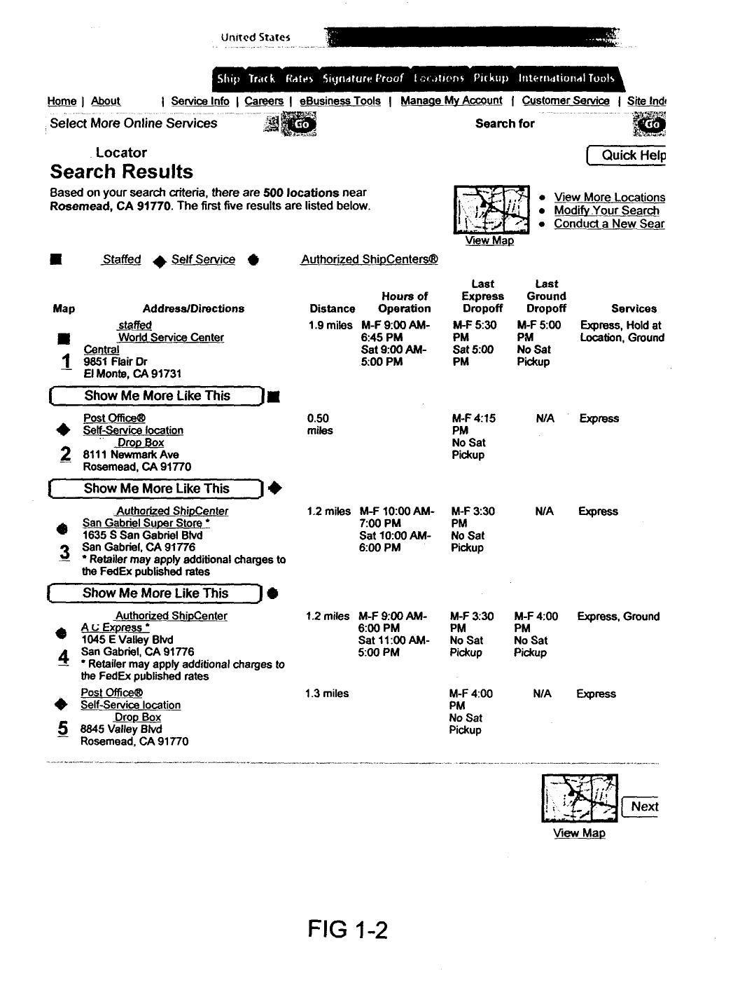

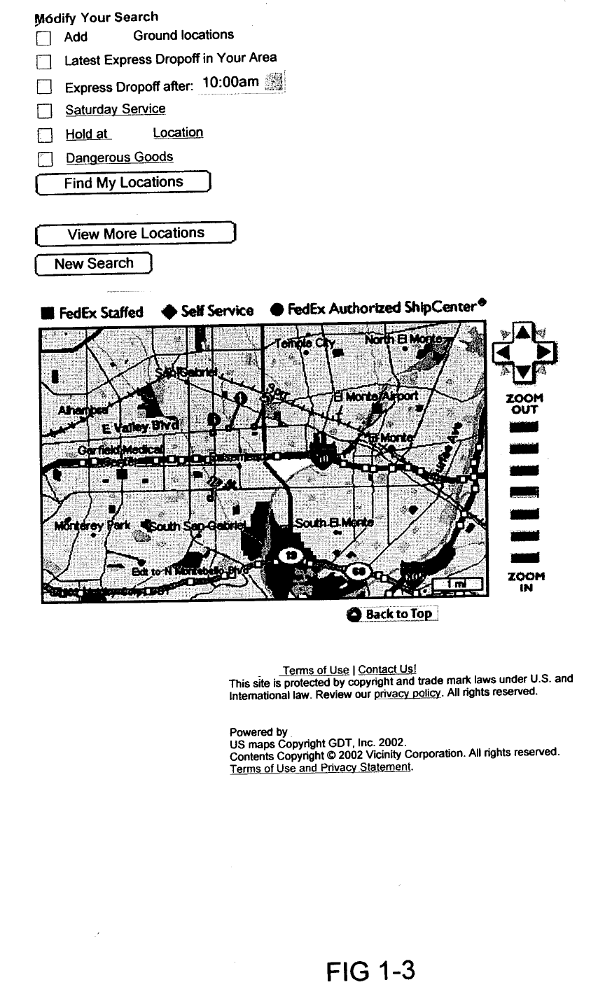

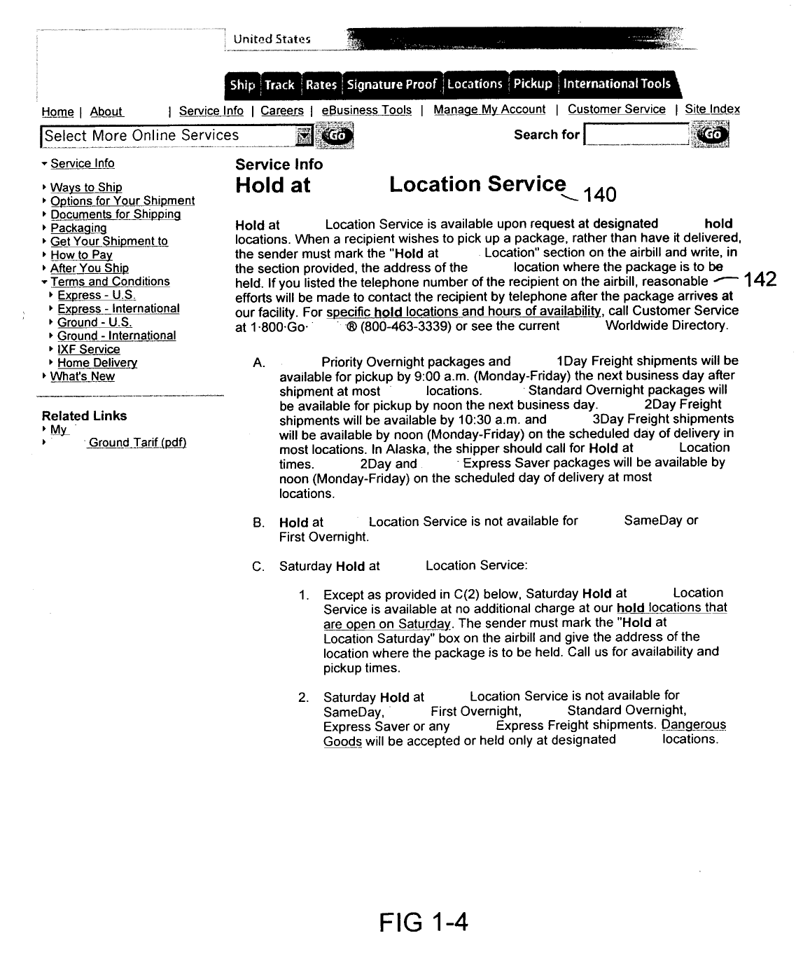

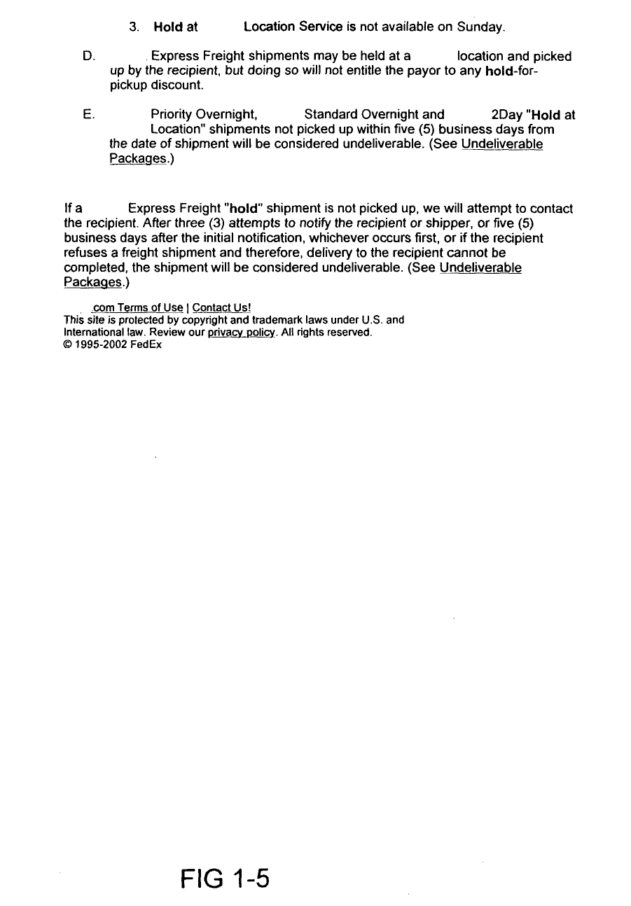

Presently, a shoppers, when purchasing goods on-line (or by phone or thr other means to place purchase orders to a remote seller), has to know beforehand the address of the location the user wants the user's orders to be shipped to. The delivery location may the shopper's home, office, friend's home or some other locations the user has prior knowledge of its address and must communicate these addresses to the seller. Refer to FIG. 1, this figure displays Amazon.com web page 110 with the part 120 the user enters the shipping address. The shipping address identifies the place the user wants the user's order to be shipped to. The seller, Amazon.com, then prepares shipping label or shipping instructions according to this information. The traditional system represented by web page 110 is the prior art and the only system that is used in Internet purchasing to date with regards to shipping information registration. The problem with the traditional system is that the system has no flexibility, i.e. the system can allow user to enter known information only. The user has to know exactly what the delivery address is to input to the system or no shipping function can proceed. Under this traditional system, no way a user can conveniently search for shipping locations to use when these locations are unknown to the user as far as their availability, addresses, location or operating hours. As described in the exemplary case, a user has to do a multiple step research if the user wants to select a pick up location to use in the case the pick up locations available to him to select are unknown or unfamiliar to him.

As an exemplary use of the present invention, a user/buyer (referred to hereafter as user), when places orders on the Internet at a seller's web site, at the time of entering delivery address and other shipping information, is linked to a third party web site. The third party, typically, is the delivery carrier, e.g. UPS, FEDEX or US Postal Service., that is hired by the seller to handle delivery of seller's orders. At the third party web site, the user is displayed with a number of available pick up locations; the user may select one or more of these locations and designates these location(s) as the place the user wants the user's orders be shipped to. The seller then arranges the goods ordered to be shipped to the selected location(s). The recipient of order may then go to the delivery location(s) to pick up the goods the user shipped.

A shipping system in accordance with the present invention has several advantages over the previously described traditional systems:

1) Under the a traditional shipper model, the user physically possesses the goods the user wants to ship in the user's hand and the user hands it over to the shipper. The user personally fills out a shipping label. It is a two party transaction. No third party, i.e. a seller, is involved in the process. Whereas in the present invention, a seller is involved in the process as the transaction is initiated in the seller's system.

2) In the traditional shipper model, the shipper presents a list or a map with all pick up offices on it. But no manipulation of the information and/or web pages is available the user. That is, no user who uses the traditional model can “click on” or select a desired location displayed either on a list or a map to transmit that location information to other Web pages for other uses as is enabled in accordance with the present invention.

An improved delivery model, as set forth below, provides an easy approach for a user to select the user's preferred pick up location and at the same time increases delivery efficiency for the shipper.

Our daily lives are sometimes described as similar to a repeating pendulum because they swing back and forth following the same routine time after time. The most notable routine people follow is that people go to work and return home by traveling the same route and spend the same amount of time day after day. This going to and coming back from work commuting is the daily “must-do” most people repeat every day. Ability to exploit such a highly routine human behavior translates into economic efficiencies. A delivery model that utilizes this routine human behavior by arranging for the goods a user has ordered to be shipped to places near the user's home or office, or to places the user passes by regularly or frequently so that the user can pick it up during the user's routine traveling makes commercial sense. The delivering location where the user passes by frequently may be those locations that are along the user's daily to and from work commuting route or along the user's frequent traveling route. It may also be a place near the user's home or office, in such a way, the user, who places orders and is not available during daytime to be home to receive the user's orders, may pick up the user's orders while traveling along the user's frequent commuting routes. By using such a delivering model, the user picks up the user's orders when the user passes by the pick up location while doing the user's daily commuting, no extra traveling to the shipper's office is necessary. This delivery model may be advantageous the shipper also, because the shipper may ship goods in a batch to a group of users to a common pick up location. The shipper then does not need to deliver those goods one by one to each recipient thereby saving shipping costs. Also, under this delivery model, customer orders are delivered to places where attendants and security measures are available. The recipient may receive the goods securely in person. Full security during delivery process may be achieved.

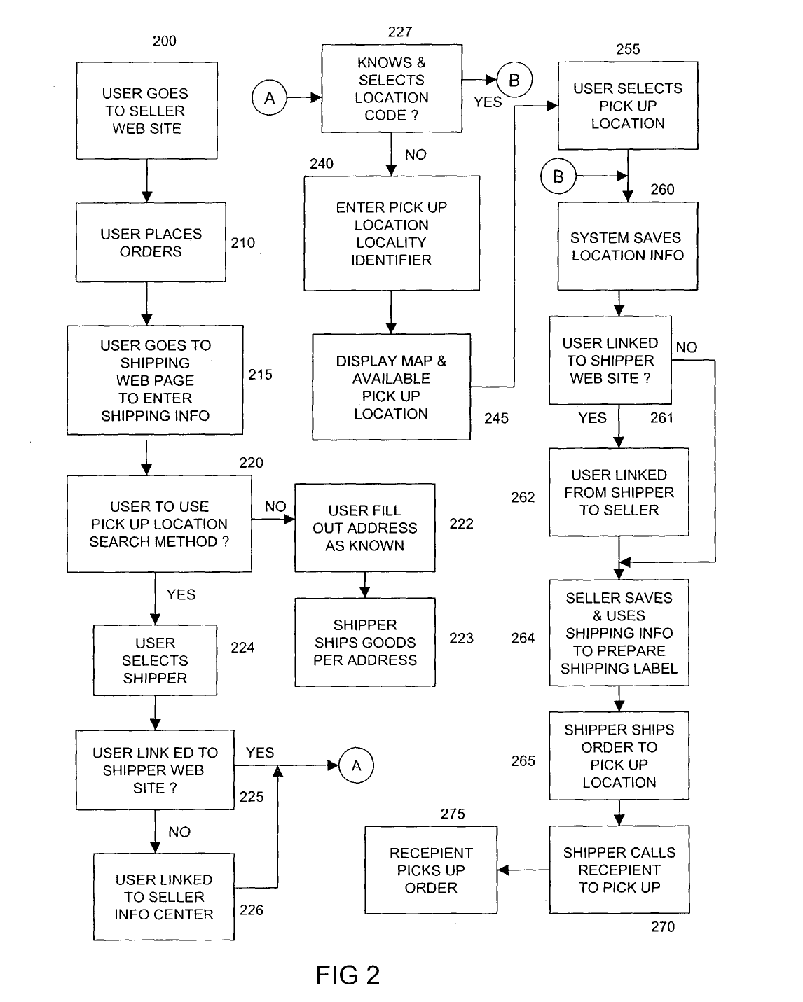

Referring now to FIG. 2, a user goes online to a seller's web site to shop (200) and places an order (210). When the user completes the user's shopping and is ready to check out, the user is prompted to enter shipping information (215). At step 220, the user decides if the user wants to use a PICK UP LOCATION SEARCH in accordance with the present invention. If the user does, the user may select the user's preferred pick up location, and the shipper may ship the user's order to this pick up location where the user (or the recipient, if the order is not shipped to the user himself) can pick up the goods the user ordered. If the user decides not to use the PICK UP LOCATION SEARCH method and wants to use a conventional delivery method, the user goes to step 222. At this stage, the user inputs the delivery address the user knows. This delivery address is the information the user knows beforehand and is required by the shipper. The shipper then ships the user's goods to the delivery address according to the user's input (223). If the user wants to use the PICK UP LOCATION SEARCH method as proposed by the present invention, the user goes to step 224 and selects a shipper. The shipper (shipping carrier) may be a third party shipper hired by the seller to deliver customer orders. The seller himself may act as the shipper if he operates a fleet of transportation equipment and delivers customer orders himself. The preferred pick up locations that the user may search to use are the locations to where user's goods will be delivered to. Goods stay there for the user to pick up. These locations are maintained by the shipper. The location may be an office of the shipper, an outlay of the shipper, or office or outlay owned or leased by an entity the shipper is affiliated with. Besides office buildings, they may be a fleet of movable facilities, such as trucks, kiosks or lockers that are loaded with user orders and park at delivery pick up locations.

At the next stage 225, the user is linked to either the shipper's web site or an information center in the seller's system. The user is linked to the shipper's web site by clicking the shipper's icon on the web page. If the user is linked to the shipper's web site, the user is asked if the user knows the pick up location codes of the locations, the user wants the user's goods to be delivered to (227). Shipper assigns each pick up location a location code to identify the pick up location and simplify its selection.

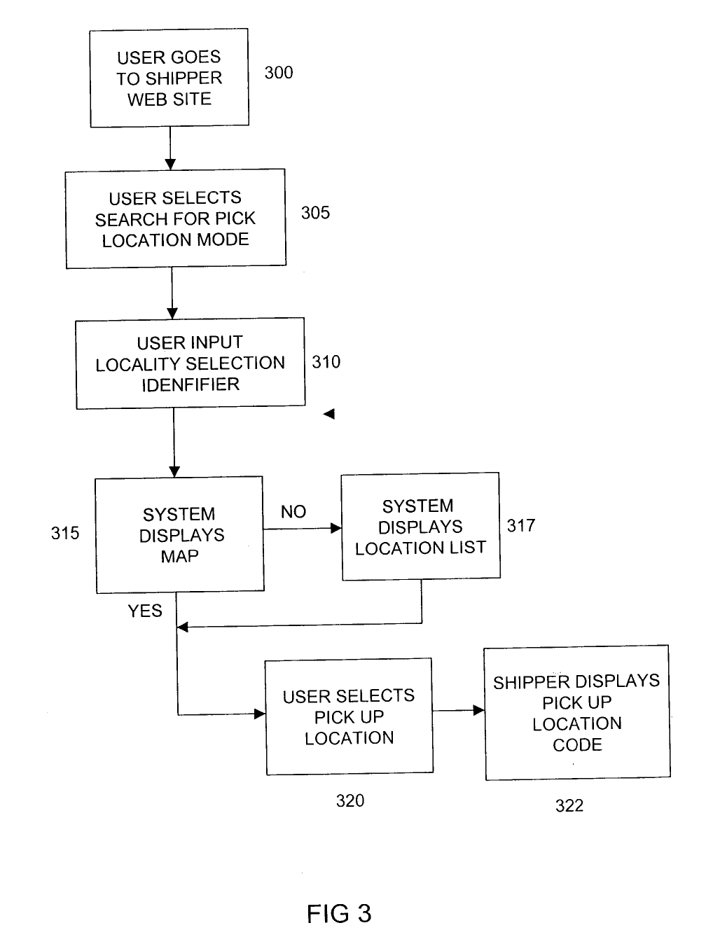

FIG. 3 describes a method of selecting pick up location codes. If a user knows the location code, the user may simply input the location code and the system knows what the user's preferred pick up location is. The system retrieves all related information to the location code. The system then saves to the user the selected pick up location code and related information 260. The other use of location code can be described as follows: Suppose a user is buying a gift for a friend and the friend wants the gift to be delivered to a preferred pick up location near the friend's office for him to pick up. The user does not know which pick up location is the most convenient for the user's friend so the user asks the user's friend to find out the location code the friend prefers to use. The friend can find out the most favorable pick up location from the shipper's web site (see steps 300 to 320 in FIG. 3) or by phone calls and passes the location code to the user. The user may then use this location code to identify the preferred pick up location. If the user is not using location code to identify preferred pick up location, the user goes to step 240.

The shipper's web site is updated frequently by the shipper for any changes in pick up locations information. That is, the system adds new pick up locations as they are available, removes pick up locations as they are not in use, or changes any information to any pick up locations. The web site also maintains other information about pick up locations such as their addresses, telephone numbers, open hours, maps, and direction instructions.

At step 240, the system provides search functions that allow the user to search for preferred pick up location(s) the user wants to use. At this step, the system asks the user to input locality identifier(s) to identify the general locality the user wants the user's order to be shipped to and picked up. The identifier may be a zip code, names of a city, a telephone number prefix, major cross streets, a home address, an office address, community land marks, etc. as long as it may identify the general pick up locality.

Once identifiers are input and the general delivery locality is defined, the system displays a map that covers the defined locality along with all available pick up locations located within this locality (245). If no map is available, the system may display a list of all pick up locations that are covered by this general locality. If the identifier the user used represents a “point of location”, e.g. the user's home, the system may set up a boundary limit around this location and display only those pick up locations within the boundary limit. For example, the system may display only those pick up locations that are within five miles from the user's home if the system set ups a five mile boundary and the user's home is the identifier. The shipper may allow the user to define the user's preferred boundary limits and the shipper display pick up locations according to these boundary limits.

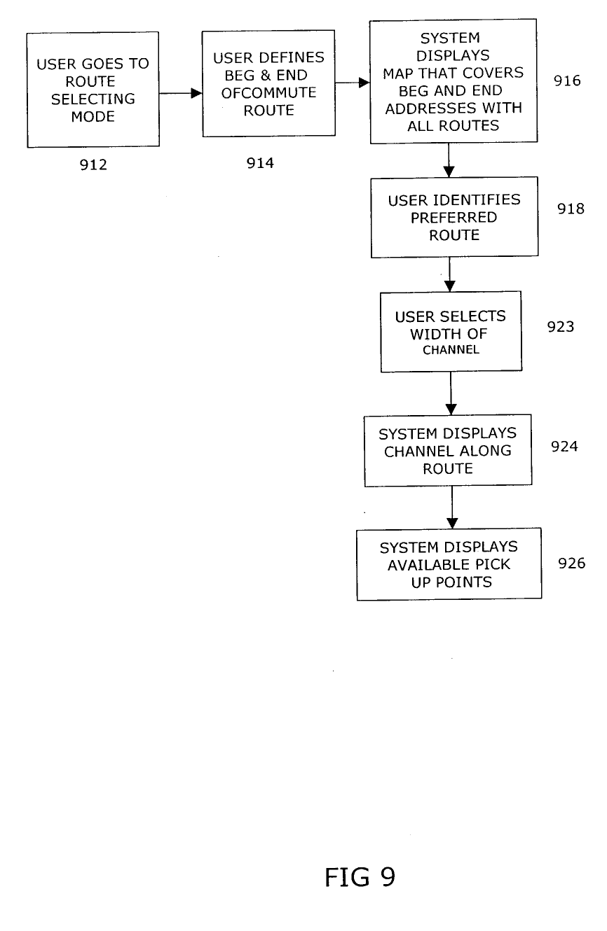

In another embodiment of the present invention, the system may ask the user to identify the user's daily (or frequent) commuting route and uses this commuting route as a locality identifier as described in FIG. 9. Referring now to FIG. 9, the user goes to a route-selecting mode at step 912. In this mode, a template is presented to the user so that the user may enter identifiers to define a beginning and an end of the user's commuting route (914). Once the beginning and the end of route are identified, the shipper server displays a map with all the streets, roads and highways between these two identifiers (916). Besides using the beginning and the end addresses to define the beginning and the end of the route, the user is allowed to enter other identifiers such as zip codes or telephone numbers at the beginning and the end to identify the route. Well-known landmarks, city names, or cross streets with city information at both ends of the user route can be used as identifiers to identify the general area of the route also.

The system may construct and display a default route to the user. A default route is the shortest route connecting two identifiers. A user's complete route is built up by connecting sub routes which are sections made up of streets, roads, or highways and finally connects to the beginning and the end identifiers. The user may modify the default route by changing sections to those sections the user prefers to travel and build the user's own preferred route. The user does so by clicking on the map at the sections of roads or streets the user wants to travel, the system then connects these sections with other sections and finally connects to the beginning and the end identifiers to build the route. In case some sections of the streets or roads are not clicked so that gaps exist and those clicked streets or roads can not be connected, the system uses the shortest route between these streets or roads to bridge the gaps. The user may also use the mouse to click on the map and drag the mouse across the map from the beginning identifier to the end identifier just like a paint brush to build a route. Upon finishing building the route, the user confirms to the system the route the user preferred to use (918). The system may, instead of asking the user to use a mouse to define the preferred route, provide places that would allow the user to input the street names or symbols (or highway names or symbol) from the key board to identify preferred sections. An entry of street names or symbols means the user wants to include these streets or highways as a part of the user's route. The server then connects these streets to form a route.

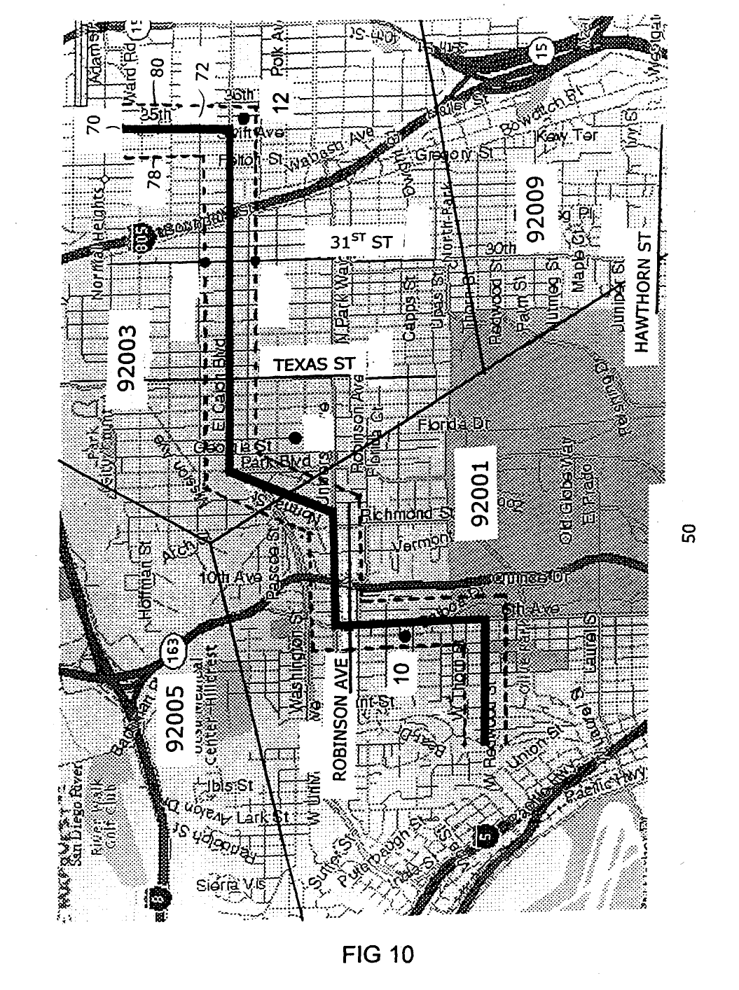

The route building process may be more clearly expressed as follows. In FIG. 10, the shipper server displays a map 50 that covers the beginning and end address of the user's commute route. The map also displays all streets and freeways between those two ends. If the user wants to build the user's preferred route on a map such as 50, the user starts with entering the user's beginning and end identifiers. Assuming the user uses the user's home address as beginning identifier, at this time the shipper server registers a reference point, which is the user's home address. The home address contains the user's home street. The user then clicks on the map at the second street the user preferred to travel. The intersection of the second street and the user's home street becomes a second reference point.

The system registers the route between the first and the second reference points as a portion of the user's chosen route. The user then clicks at a third street the user prefers to travel. The intersection of the second and the third street becomes a third reference point. The shipper server then registers the route between the second and the third reference points as a portion of the user's preferred route. The user keeps going on with the process until the user reaches the user's end address, which is the end identifier and it is also the user's final reference point. The shipper server registers the final route portion and the connection of all routes thus becomes the user's preferred route.

Alternatively, the user may start a route selecting process by clicking on the map one of the streets within the user's commuting route, the user then clicks on the map the streets the user travels before and after that street. The system then uses the intersections of these streets to establish reference points for the shipper server to construct the user's route. In the case where the user forgets or neglects to click to identify any of the traveled street(s) within the user's route, the system searches street(s) that represents the shortest traveling distance between the clicked streets and connects those clicked streets. The same method can be used to connect the clicked streets to the user's beginning and/or end identifier of route. For example, if the user clicks the second and the fourth traveling streets, thus creating a set of sub-routes, and forgets to click the third traveling street in the route, the system then generates a route by connecting the second and the fourth street with street(s) with a sub-route that represents the shortest distance between the two sub-routes to complete a whole route. In another embodiment of a route selection system in accordance with the present invention, after the user enters telephone numbers, zip codes, city names or landmarks as identifiers to identify the beginning and the end of a route, the system displays a map that covers the general area of the route as previously described. The user can then use the user's mouse to point the cursor at the places the user wishes to travel, and click on them. The system will then register those clicked points as reference points to establish the route. This method can be used to establish the beginning and end of a user route.

In another embodiment of a route selection system in accordance with the present invention, the system may present to the user a default route with the shortest travel distance when the beginning and the end of the route are determined. Major highways and/or major streets may be incorporated into the default route by default. The user is allowed to change any portion of the default route as the user wishes. A template may be provided to the user to enter via keyboard the highways or streets user wants to travel. A drop down menu that contains defaulted streets and/or highways may be used to allow the user to click on and select the user's desired traveling route.

In another embodiment of the present invention, a user is prompted to enter distance from the user's chosen route to produce a channel. The distance from the user's chosen route to the channel is the distance the user is willing to travel is herein termed a channel width. The channel width on each side of a route may differ in length. In FIG. 10, for example, the user chooses a channel width ¼ mile on each sides. The shipper server displays two channel boundaries 78 and 80 that wrap around and extend along the chosen route 70 with the distance from a boundary to the chosen route equal to ¼ mile. The area between the channel boundaries defines a channel around the chosen route. The channel boundaries 78 and 80 which extend along and around the chosen route are defined by channel widths. The two channel width combined with the user's chosen route forms channel 72. The shipper server displays all available pick up points 10 and 12 covered by the channel. The user may click or depress-and-drag the mouse across the map to define the user's preferred route 70 as described before.

Referring again to FIG. 9, the user identifies the user's preferred route at step 918. The user then selects a width for the shipper server to develop a channel around a chosen route at step 923 as previously discussed. The shipper server then displays a channel that wraps around and extends along the route at step 924 with the defined width. The shipper server then displays all available pick up location within the channel (926).

Referring again to FIG. 2, the user selects a pick up location the user wants the user's orders to be shipped to at step 255. The pick up location the user wants the user's order to be shipped to is termed a preferred pick up location. The user may make the user's selection by clicking at the location displayed on the map or clicking at the location on the list. The map displays all available pick up locations defined by identifiers as does the list. After the pick up location is selected, the system receives the selected pick up location and associates the selected pick up location with its address and other information such as, telephone number, hours of operation, etc. The address and other information of the selected pick up locations are then saved and ready for transmitting to other web pages or web sites (260). If the user is not linked to the seller's information center but is linked to the shipper's web site, the user is transferred back from the shipper's web site to the seller's web site (262). The shipper's system also transmits the saved pick up location information (such as address, location code, etc.) to the seller's system and saves these information in the seller's system. The system may automatically register the selected pick up location as a delivery destination. Or the system may display the selected pick up location information to the user and ask the user to re-enter these information to register. The seller's system then uses this information to prepare a shipping label (264). The shipper then ships the order according to the shipping label.

In another embodiment of the present invention, the user is at the shipper's web site and selects preferred pick up locations, the user selects from the displayed available pick up locations to make the user's selection (255). The shipper's web site displays the address or other i.d. (e.g. location code) that identifies the selected pick up location. The user makes a note for this address or i.d. and returns to the seller's web page. The user then manually enters the address or location i.d. information, which is the same information the user gets from the shipper's web site, to the delivery web page to register the location as a delivery location. The seller then prepares a shipping label and ships according this information.

The seller may, as may be required by the shipper, finish some of the administrative work when preparing the shipping label. For instance, the seller may be required to check a special box such as “hold for pick up” on the shipping label, so that the shipment is identified to be held at the shipper's office. The shipper then ships the customer's order to the pick up location as designated (265). When the goods arrive at the delivery pick up location, the shipper calls the recipient by phone or sends a post card to the recipient to notify him to pick up the order (270). The recipient then goes to the pick up location to pick the order (275).

In another embodiment of the present invention, at step 270 the shipper notifies the recipient of the arrival of the user's order. Instead of using phone calls as used by some shippers, the shipper may ask the user to provide the user's and/or the recipient's e-mail addresses in the beginning of the process when the user registers the user's address and other information. The shipper then sends out e-mails to notify the user and/or the recipient of the arriving of package at the destination office. The shipper's destination office installs a scanning system coupled to the destination office's computer and is further coupled to the destination offices e-mail module. Upon receiving of the incoming packages (orders), the destination office scans the shipping label on the package and registers the arrival of the package. The system then sends e-mail to the user and/or the recipient, notifies them the arrival of order/package, and reminds the user/recipient to pick it up.

In another embodiment of the present invention, the seller's system, instead of linking the user to the shipper's web site 225 to search for and select pick up location information, may transfer the user to an information center in the seller's own system (226). The information center is a web site that is maintained by the seller and within the seller's system. The information center includes the shipper's available pick up location information and is updated constantly and frequently by the shipper. The shipper updates all sellers who use the shipper's service regarding the addition, removing or changing of available pick up locations and their information. The updating can be done through linking the seller's web site to the shipper's web site and transmitted constantly. Alternatively, the shipper can send this updated information to a seller by sending to the seller CDs or diskettes that contains such information. Within this procedure, the user is still asked to identify the general pick up locality and complete those steps as described in steps 227 to 260 of FIG. 2 and the seller still finishes administrative work as may be required by the shipper as mentioned before. In this embodiment, the system provides basically the same function and procedures and the user is basically follows the same selection procedure to select preferred pick up location as the user is transferred to the shipper's web site as described before. The difference is at this embodiment, the user stays in the seller's system and goes to the information center inside the seller's system to perform search and selection of preferred pick up location. In this embodiment, the user stays in the seller's system and goes to the information center inside the seller's system to perform search and selection of preferred pick up location. The seller's information center is updated by the outside shipper for the shipper's pick up location information on a constant and regular basis.

Referring again to FIG. 3; a user may obtain a pick up location code by following the steps described as follows. The user goes to the shipper's web site (or goes to an information center if used) (300). The user selects a “Search for Pick Up Location” mode by selecting its icon (305). The user then inputs a pick up location selection identifier (310). The pick up location identifier may be a zip code, a telephone number, a home address, an office address, or traveling routes as previously described. The shipper web site displays a map the covers the locality defined by the user input identifier (315). If no map is available, a list including all available pick up location is presented to the user (317). The user selects a preferred pick up location by selcting on the map at the location or selecting on the list at the location (320). The system displays location code pertaining to the pick up location selected (322).

In another embodiment of the present invention, the user is permitted to select more than one preferred pick up location the user prefers to use. The shipper then decides which one(s) of those preferred pick up locations selected by the user the shipper will ship the user's order to. The shipper then notifies the user the location the user's order will be shipped to. The user (or the recipient if not the user himself) then goes to the location to pick up the user's order.

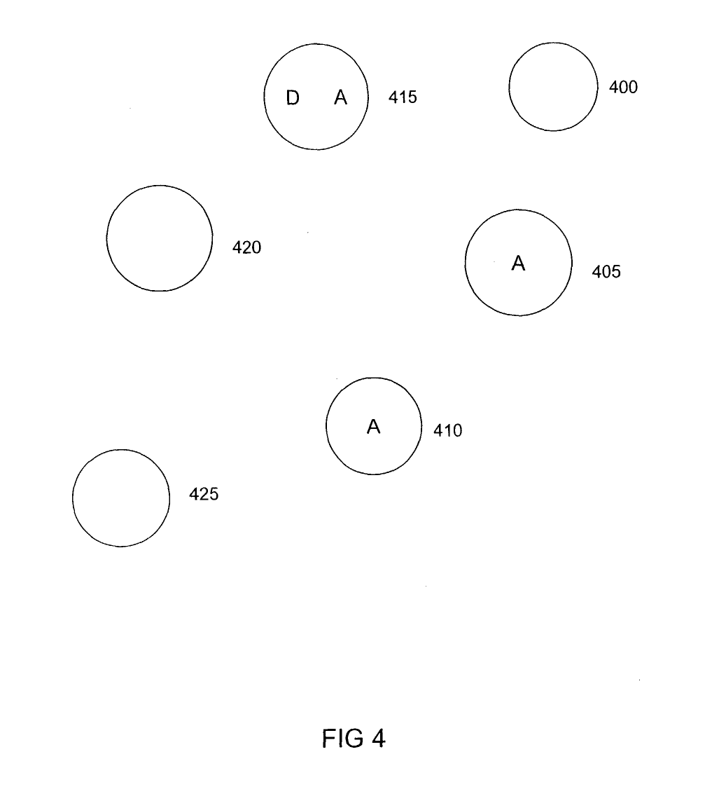

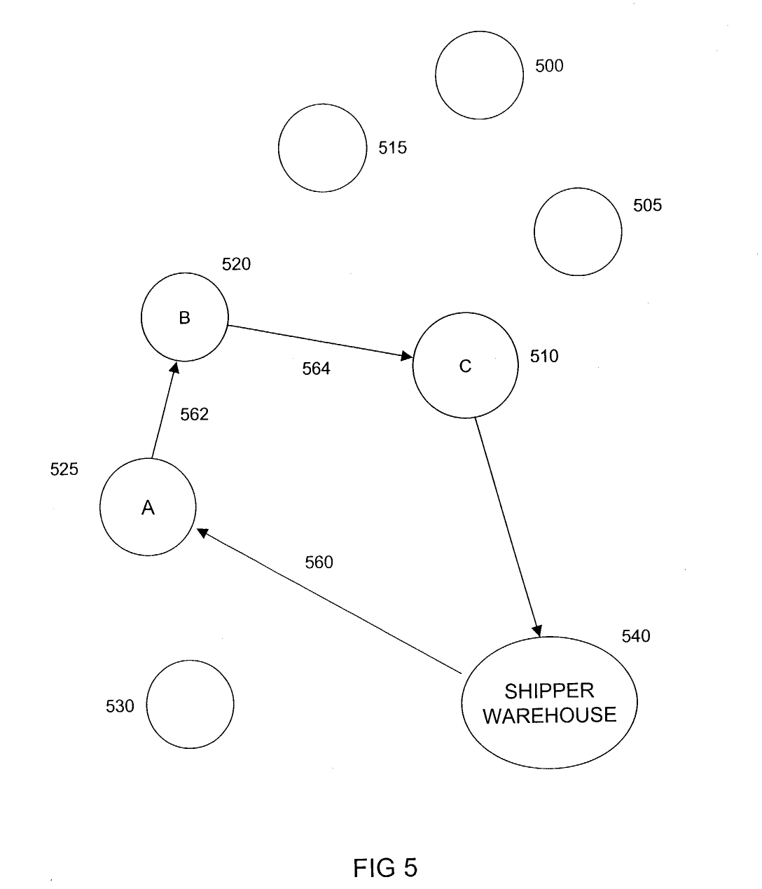

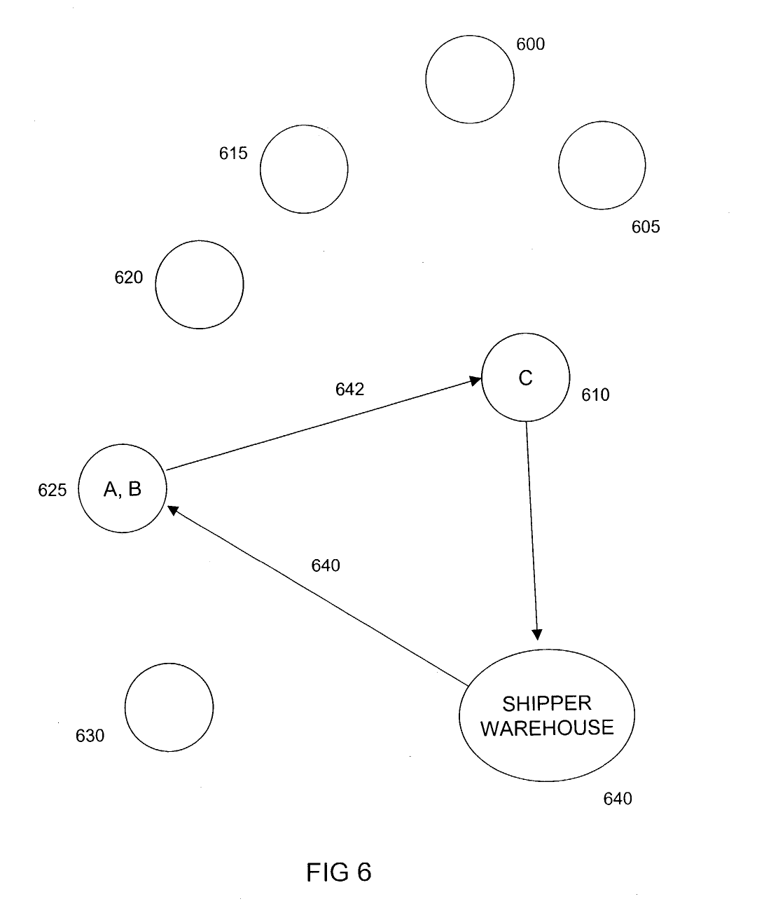

The advantage of allowing user to select multiple pick up locations will be understood as explained in the following paragraphs. Referring now to FIG. 4, 400, 405, 410, 415, 420 and 425 are all pick up locations set up by a shipper and available for selection by a user. Those pick up locations may be an office, outlay, or warehouses owned or leased by the shipper. The pick up locations may also be movable trucks, kiosks or lockers owned or leased by the shipper loaded with orders and stationed at the pick up locations. User A selects 405, 415, and 410 as his preferred pick up locations as indicated by letter A. The shipper then decides which location A's goods will be shipped to. Referring now to FIG. 5, assuming the shipper decides that it will ship user A's order to pick up location 525, B's order to location 520 and C's order to location 510, the shipper S 540 has to trave three shipping routes, namely, 560, 562, and 564 in order to complete shipment to all three users. Referring now to FIG. 6, if user A's selected preferred pick up location is 620 and 625 and user B's selection is 625 and 630, shipper S 640 assigns user A's and user B's orders to a common pick up location 625 and assigns user C's order to location 610, shipper S only has to make two shipments 640, 642 to complete shipping to all users. The shipper saves traveling one shipment route to complete shipment as compare to the example in FIG. 5. It is therefore to the shipper's advantage if the shipper assigns and ships shipments to common pick up locations. A common pick up location is a location that is commonly selected by more then one user as preferred pick up location. The shipper finds it favorable to ship orders to common pick up locations, because by so doing, the shipper may save shipping costs. To allow users to select more than one preferred shipping locations increases the chance that users may be assigned to common pick up locations.

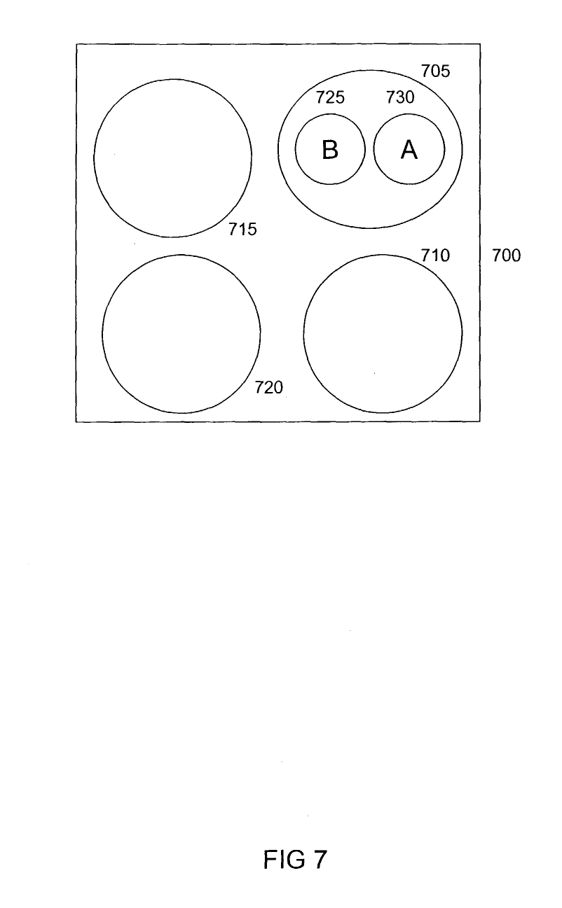

To further understand this concept, referring now to FIG. 7, 700 is a business community with only 4 pick up locations 705, 710, 715 and 720. Assuming there are only two users A and B in this community and each of A and B can select only one preferred pick up location. The chance of A and B to select the same pick up location 725, 730, is ¼. If A and B each may select 2 preferred pick up locations, the chances of A and B to be assigned to the same pick up location increase to ⅚, an increase of over 3 times.

In another embodiment of the present invention, the shipper may assign a user's order to a pick up location that has already been selected by other users when multiple preferred pick up location selection is allowed. For example, referring again FIG. 4, D is a user who has been assigned to 415 as his delivery pick up location. When user A goes to the system and selects 405, 410 and 415 as his preferred pick up locations, the system may assign 415 as A's delivery pick up location and ships A's order to 415. By such an arrangement, A and D create a common pick up location, namely location 415. A common pick up location is a location that is shared by more then one user. Making shipments to common pick up locations obviously saves costs for the shipper.

The shipper may assign a priority to each available pick up location with regards to the assignment of pick up location to users if the shipper knows which pick up locations are more popular (used more frequently) than the others. For example, referring again to FIG. 6, suppose the shipper knows location 625 is used more frequently by all users. When the first user A comes in with two preferred pick up location selections 620 and 625, the shipper may assign pick up location 625 to A because pick up location 625 is more popular and has a higher possibility to be used by subsequent users. The higher possibility of use by users warrants a higher priority. Assuming user B comes in later with a preferred location selection of pick up locations 625 and 630. User B is assigned to pick up location 625 also because pick up location 625 is already assigned to A and assignment of B to pick up location 625 will create a common pick up location. User C then comes in with preferred pick up locations 605 and 610. User C does not get assigned to pick up location 625 because pick up location 625 is not C's preferred location selection. User C is assigned to pick up location 610, because pick up location 610 has a higher priority then pick up location 605.

In another embodiment of the present invention is, the shipper, by its own experience, may know which pick up locations are more popular (or used more frequently) then the others. The shipper may then assign “dummy” user(s) to that pick up location so that the system may “see” that location has already been used and assign subsequent users to that pick up location. For instance, referring again to FIG. 4, 415 is a more popular pick up location. The shipper assigns D, a dummy user, to pick up location 415. When user A comes in and selects pick up locations 405, 410 and 415 as his preferred locations, the system will see D as a user who already exists and assigns A's goods to be shipped to pick up location 415 to create common pick up location.

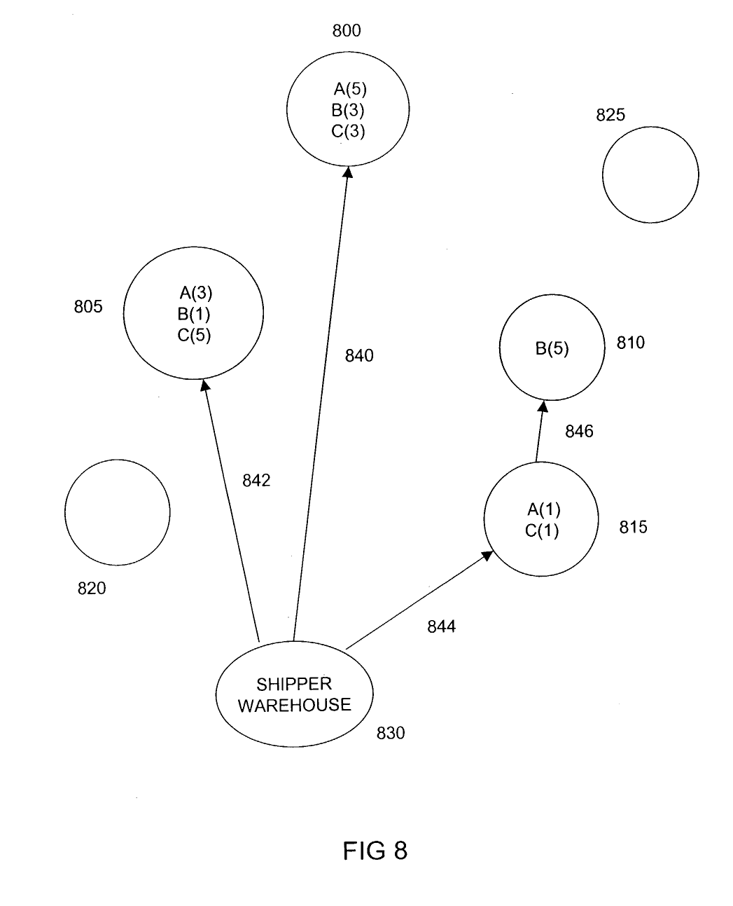

In another embodiment of the present invention, the user is allowed to prioritize those pick up locations available to the user for selection. For example, referring again to FIG. 4, the user may prioritize pick up location 415 as the user's first choice of pick up location selection, pick up location 405 as the user's second choice as shipping location and pick up location 410 as the 3rd choice. The shipper may then quantify these priorities by assigning weight points to each user's preferences. For instance, the shipper system may determine to assign 5 weight points to a user's first choice of pick up location, 3 weight points to the user's second choice and 1 weight points to the third choice. The weight points represent the relative importance of each pick up location to the user in choosing pick up locations. The shipper may determine those weight points by performing marketing research, inquiry of customers or survey to customers. Alternatively, the shipper may ask the user to quantitatively rank the user's or her own preferences. For example, the shipper may ask the user to assign weight points to each of the pick up points selected on a scale of 1 to 5. User A may then, according to the user's own judgment, assign 5 points to the user's most favorite pick up location, 4 points to the next favorable pick up location and 1 point to the least favorite pick up location. The system may then summarize all weight points assigned to each pick up location and determine which pick up location the shipper selects to ship customer goods to. Referring now to FIG. 8, pick up locations 800, 805, 810, 815, 820, 825 are all available pick up locations. Location 830 is the shipper's warehouse. Symbol A(5) within location 800 means user A regards this location 800 as his most favorable selection of pick up location and he assigns 5 weight points to this location. By the same token, A(1) appearing in location 815 means location 815 is of the least importance to user A and the user assigns only 1 weight points to this location. Similarly, C(3) means user C regards the pick up location 800 as moderate importance to him and user C assigns 3 weight points to it. It is obvious that the shipper has to ship all user orders to all users A, B and C to complete his shipping assignment. In this regard, the shipper has three options to complete the assignment, 1) select 800 as a common pick up location and ship all goods to location 800 via route 840, 2) select 805 as a common pick up location and ship all goods to location 805 via route 842, or 3) ship all goods to location 815 and location 810 via routes 844 and 846 respectively. As pick up point 800 has been selected commonly by all 3 users A, B and C and the total weight points assigned to this location is 11 points (computed as 5 points (assigned by user A) plus 3 points (assigned by user B) plus 3 points (assigned by user C)). For the same reason, the total weight points assigned to location 805 is 9 points and the total weight points assigned to locations 810 and 815 is 7 points. It is obvious that shipping all goods to location 800 will reach the maximum customer satisfaction, as the weight scores from users is the highest. The user may therefore disregard all other shipping locations and ship all orders to location 800.

Other factors may be considered by the shipper when making delivery location selection decision, such as: distance from shipper warehouse to each location; rent expense incurred on each location; ease of parking on each location . . . etc. The user may assign each of those factors similar weight points to quantify the relative importance of each factor.

When the shipper assigns a delivery pick up location to a user among the user's selected preferred pick up locations, the shipper needs to notify the user of the assignment or the user will not know which preferred pick up location the user's order will be shipped to. The delivery pick up location is the location the user's order will be shipped to. The shipper decides a delivery pick up location among those preferred pick up locations selected by the user. There are two methods the shipper may use to notify the user regarding delivery pick up location assignment. In the first method, the shipper may set up a cut off time. Before the cut off time, the shipper allows all users to select and enter their preferred pick up location selections. After the pick up time, the shipper processes and matches all preferred pick up location selections to produce the best shipping portfolio and notifies these assignments to users. For example, the shipper may set up the cut-off time at 4:00 P.M. All users can select their preferred pick up locations before that time. At 4:00 P.M., the shipper starts to process all users' shipping information, such as matching user preferred location selections, quantifying user preference, quantifying other pick up location selection criteria, etc. to find out the most efficient delivery portfolio for all users. The shipper then notifies users where their assigned delivery pick up locations are and then ships user orders according to this delivery portfolio. The other method involves a real time notification to a user of the user's assignment of delivery pick up location. In this method, the shipper determines certain rules (or criteria) that will trigger assignment of pick up locations. Once the assignment rules are satisfied, notification is sent to the user real-time and the user is assigned to that delivery pick up location. For example, the shipper may determine the rules as: as long as a user selects a preferred location that has any user in it, the user will be assigned to that location and notification is sent to the user telling him that the user's order will be shipped to that location. Referring again to FIG. 4, assuming D has already in location 415, user A comes along and selects pick up location 405 and pick up location 415 as the user's preferred locations. Because D is already in location 415, the system will immediately assign user A to location 415 and send a notification to user A, telling user A the user's order will be shipped to pick up location 415 and user A can pick up user A's order there. Examples of other rules are: if no prior user is within the user's selected preferred pick up locations, a user will be assigned to the preferred pick up location with the highest priority set up by the shipper and notice will be sent to the user of that effect. For example, in FIG. 4, assuming in the beginning, user D is the only user and user D selected pick up locations 420 and 415 as the user's preferred locations. The shipper assigns location 415 to user D as user D's delivery pick up location and sends a notice to user D telling user D to come to pick up location 415 to pick up user D's order. Shipper assigns user D to pick up location 415 because pick up location 415 is a pick up location that is used more frequently than other pick up locations and is determined to have higher priority.

In accordance with the present invention, as stated before, a user may select the user's traveling route in a web site that is maintained by a shipper or in a web site called the information center that is within a seller's system and updated by the shipper. The shipper's web site or the information center, maintains a system that is capable of displaying all routes between the selected route identifiers, displaying a default route and allowing the user to select the user's preferred traveling route. The system may be developed and/or maintained by the shipper. It may also be developed and/or maintained by an outside entity and sold or licensed to the shipper to use.

In another embodiment of the present invention, there is another option of building a preferred route. In this embodiment, the shipper or the outside entity that develops and/or maintains the route selecting system may display to the user a route that takes the least time to travel through. A Least Travel Time Route (LTTR) is built as follows. A street or road of a city or a region consists of a number of blocks (or sections). A section is defined as a portion of the street or road that consists of several blocks. The shipper or the outside entity that develops and/or maintains the route selecting system may measure the time a driver spends in traveling through each section in the region. The developer may do so by hiring drivers who drive through each block in the region on different days and at different times in a day. The drivers then record the time spent and speed in completing each block. For example, the developer may hire drivers to drive through each block in a city from Monday thru Sunday and from 5:00 a.m. to 8:00 p.m. each day. The drivers then record the speed and time it takes to travel and finish each block in the city by time and day. Because stop signs, signal lights, and possible construction zone involved on the streets, the driver may record the time it takes to stop at stop signs, signal lights, and construction sites as well. The driver may also record the time it takes to finish a section of the street which consists of several blocks. These records are stored in the developer's system. When a user logs on to the route selecting mode and enters the beginning and end route identifiers, the time and day of the traveling, the system finds a route that takes the least time to complete, the LTTR, and presents it to the user. The system finds the LTTR by building all the routes that connects to the beginning and the end route identifiers input by the user. The system then adds up, for all the routes, the time to complete a route. The time to complete a route is the total of time it spend on all blocks (or sections), on all stop signs, signal lights and construction sites in a route for the time and day the user specified. The route with the least time to complete is the LTTR and is presented to the user. Instead of having the driver record the time and speed when traveling through each block, section, stop sign, signal light, etc., the developer may install a radio signal transmitter on the driver's car. By tracking the signals transmitted from the driver's car, the developer may record the time and speed the driver travels thru each block, stop sign, etc.

In another embodiment of the invention, another option to survey the time and speed when traveling on each block (or section) of a street is provided. In this embodiment, the developer may use satellite images to determine the time and speed a car travels on a street. For example, a satellite image collected by the developer on Jan. 3, 2003, 08:31:30 may show a car at one spot on a street, few minutes later, another image shows the same car at a different spot on the same street. Collection and analysis of these images will enable the developer to determine the time a traveler spends traveling through a particular block or section, the time a traveler spends on waiting at a particular signal light, etc. on a given day and at different times of the day.

The user may then enter to the system the time and day of the traveling. The system may, according the time (e.g. 8:00 a.m. or 11:00 a.m.) and the day (e.g. Monday or Sunday) entered, figure out the LTTR and present it to the user.

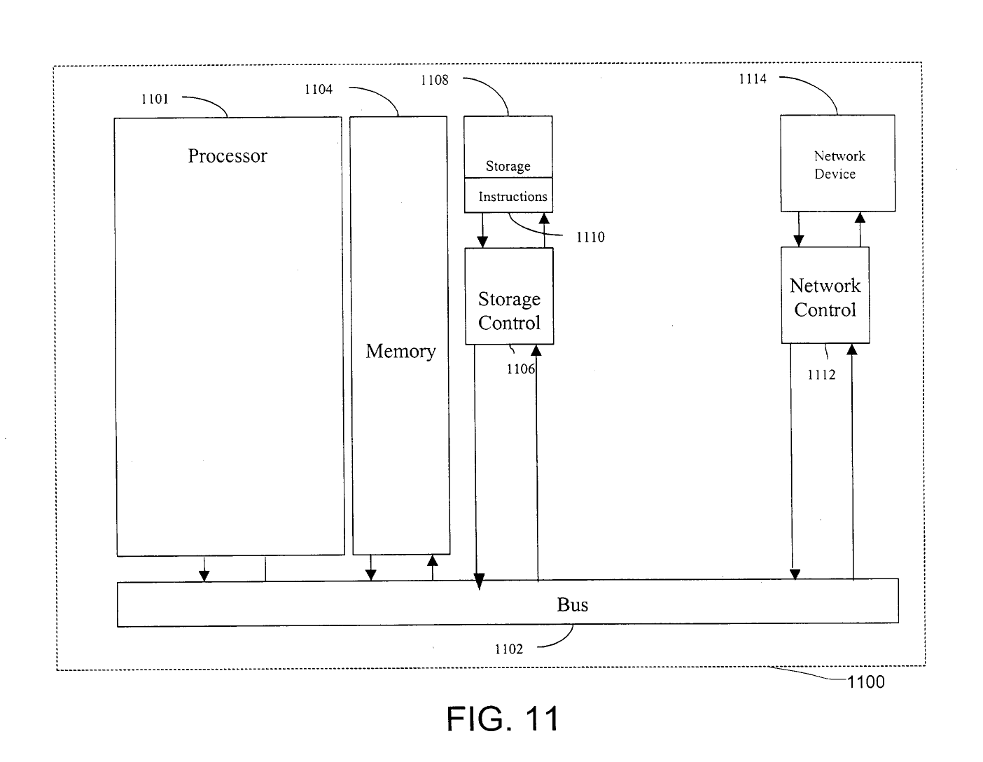

FIG. 11 is a block diagram of an architecture of a data processing system suitable for use as a shipper server host in accordance with an exemplary embodiment of the present invention. A shipper server host 1100 is used to host a shipper's web site or a shipper's server capable of generating pick up locations or routes in response to user's selections as previously described. The shipper server host includes a processor 1101, operatively coupled via a system bus 1102 to a memory 1104. The processor is further operatively coupled via the system bus to a storage controller 1106. The storage controller is operatively coupled to storage device 1108. Program instructions 1110 implementing an shipper server are stored in the storage device until the processor retrieves the program instructions and stores them in the memory. The processor then executes the program instructions stored in the memory to implement the features of the shipper server as previously described.

The processor is further coupled via the system bus to a network controller 1112 which is coupled to a networking device 1114. A shipping server uses the networking device to receive pick up location and route requests and transmit selected pick up locations and generated routes as previously described.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supported by this application and the claims' equivalents rather than the foregoing description.

What is claimed is:

1. A method of selecting a pick up location by a user, comprising:
transmitting a pick up location request by a first server to a second server through a communications network;
receiving a locality indicator by the second server from the user;
generating a set of pick up locations by the second server using the locality indicator;
generating a pick up location selection display by the second server using the set of pick up locations;
receiving a pick up location selection by the second server from the user using the pick up location selection display;
generating a pick up location by the second server using the pick up location selection; and
receiving the pick up location by the first server through the communications network.

2. The method of claim 1, wherein the pick up location selection display includes a map indicating the location of each pick location in the set of pick up locations.

3. The method of claim 1, wherein the pick up location selection display includes a list indicating the location of each pick up location in the set of pick up locations.

4. The method of claim 1, wherein the locality indicator is a route traveled by the user and receiving a locality indicator further comprises:
receiving a first route end by the second server from the user;
receiving a second route end by the second server from the user; and
generating the route traveled by the user by the second server using the first route end and the second route end.

5. The method of claim 4, wherein generating a set of pick up locations further comprises selecting pick up locations within a specified distance from the route traveled by the user for inclusion in the set of pick up locations.

6. The method of claim 4, wherein the route traveled by the user is a least travel time route, the method further comprising:
providing a set of sections with corresponding travel times; and
generating the least travel time route using the set of sections and corresponding travel times.

7. The method of claim 1, wherein generating a set of pick up locations further comprises selecting pick up locations within a specified distance from the locality indicator for inclusion in the set of pick up locations.

8. The method of claim 1, wherein the second server transmits the pick up location to the first server through the communications network.

9. The method of claim 1, wherein the user transmits the pick up location to the first server through the communications network.

10. The method of claim 1, wherein a pick up location selection includes a set of preferred pick up locations and generating a pick up location further comprises:
receiving a second pick up location selection from a second user; and
generating a pickup location from the intersection of a set of preferred pick up locations included in the pick up location selection and a second set of preferred pick up locations included in the second pick up location selection.

11. A method of generating a least travel time route for a user, comprising:
providing a set of sections with corresponding travel times;
receiving a first route end by the second server from the user;
receiving a second route end by the second server from the user; and
generating the least travel time route using the first route end, the second route end, and the set of sections with corresponding travel times.

12. A data processing system for selecting a pick up location by a user, comprising:
a processor; and
a memory coupled to the processor, the memory having program instructions executable by the process stored therein, the program instructions including:
receiving a pick up location request from a first server through a communications network;
receiving a locality indicator from the user;
generating a set of pick up locations using the locality indicator;
generating a pick up location selection display using the set of pick up locations;
receiving a pick up location selection from the user using the pick up location selection display;
generating a pick up location using the pick up location selection; and
transmitting the pick up location to the first server through the communications network.

13. The data processing system of claim 12, wherein the pick up location selection display includes a map indicating the location of each pick location in the set of pick up locations.

14. The data processing system of claim 12, wherein the pick up location selection display includes a list indicating the location of each pick up location in the set of pick up locations.

15. The data processing system of claim 12, wherein the locality indicator is a route traveled by the user and the program instructions for receiving a locality indicator further comprise:
receiving a first route end by the second server from the user;
receiving a second route end by the second server from the user; and
generating the route traveled by the user by the second server using the first route end and the second route end.

16. The data processing system of claim 15, wherein the program instructions for generating a set of pick up locations further comprise selecting pick up locations within a specified distance from the route traveled by the user for inclusion in the set of pick up locations.

17. The data processing system of claim 15, wherein the route traveled by the user is a least travel time route, the program instructions further comprising:
providing a set of sections with corresponding travel times; and
generating the least travel time route using the set of sections with corresponding travel times.

18. The data processing system of claim 12, wherein the program instructions for generating a set of pick up locations further comprise selecting pick up locations within a specified distance from the locality indicator for inclusion in the set of pick up locations.

19. The data processing system of claim 12, wherein a pick up location selection includes a set of preferred pick up locations and the generating a pick up location further comprises:
receiving a second pick up location selection from a second user; and
generating a pickup location from the intersection of a set of preferred pick up locations included in the pick up location selection and a second set of preferred pick up locations included in the second pick up location selection.

20. A data processing system of generating a least travel time route for a user, comprising:
a processor; and
a memory coupled to the processor, the memory having program instructions executable by the process stored therein, the program instructions including:
providing a set of sections with corresponding travel times;
receiving a first route end from the user;
receiving a second route end from the user;
generating the least travel time route using the first route end, the second route end, and the set of sections with corresponding travel times.
